(19) United States
(12) Patent Application Publication
(10) Pub. No.: US 2026/0340472 A1
(43) Pub. Date: Oct. 29, 2026

(54) ADAPTIVE CANARY QUBIT SYSTEM WITH REAL-TIME NOISE MAPPING AND TELEMETRY INTEGRATION FOR QUANTUM ERROR MANAGEMENT

(71) Applicant: Dell Products L.P., Round Rock, TX (US)

(72) Inventors: Navjot Kaur Khaira, Manotick (CA); Tejinder Singh, Manotick (CA); Brendan Healy, Haddonfield, NJ (US)

(21) Appl. No.: 19/189,213

(22) Filed: Apr. 24, 2025

(51) Int. Cl. G06N 10/70

(52) U.S. Cl. CPC G06N 10/70

(57) ABSTRACT

The technologies described herein are directed towards using spare (unused with respect to active use by a quantum process) qubits as “canary” qubits that are measured, after application of a sequence of gates, to detect whether decoherence or noise adversely affected active qubits used in a quantum processing unit. An adaptive canary qubit system obtains telemetry data from sensors in a quantum system, and uses the telemetry data to update a noise map and rank noisy “hotspot” regions” of the quantum processing unit by noisiness. A canary qubit assigned to a hotspot region has its state measured after application of a gate sequence. If the spare qubit is in an error state, the adaptive canary qubit system reassigns an active logical qubit from that hotspot region to a less noisy region. The system includes a model that predicts placement of canary qubits based on historical telemetry data and prior results.

### BACKGROUND

Quantum processing units are highly sensitive to environmental noise, causing significant decoherence that impacts computational efficiency. Indeed, some of the significant challenges that quantum processing units face are from environmental noise and decoherence, which introduce noise and undermines the fidelity of computations. Certain processors (and certain algorithms) are likely to produce results that are so impacted by error and noise that no useable signal remains, and thus no meaningful result can be obtained.

### BRIEF DESCRIPTION OF THE DRAWINGS

The technology described herein is illustrated by way of example and not limited to the accompanying figures in which like reference numerals indicate similar elements and in which:

FIG. 1 is a block diagram representation of an example a hybrid classical-quantum system in which an adaptive canary qubit system is deployed in a computing system coupled to a quantum processing unit, in accordance with various example embodiments and implementations of the subject disclosure.

FIG. 2 is a block diagram representation of an example a hybrid classical-quantum system in which tunable components are deployed in a dilution refrigerator before a qubit chain to adjust microwave signals directed towards the qubit chain, in accordance with various example embodiments and implementations of the subject disclosure.

FIGS. 3 and 4 depict an example hybrid classical-quantum system for controlling and sensing telemetry data, in accordance with various example embodiments and implementations of the subject disclosure.

FIG. 5 is a conceptual representation of a quantum computer including a dilution refrigerator with qubits and cryogenic tunable components operating at qubit temperatures, in accordance with various example embodiments and implementations of the subject disclosure.

FIG. 6 is a block diagram showing components of one example canary qubit system implementation, in accordance with various example embodiments and implementations of the subject disclosure.

FIG. 7A is a representation of two example quantum gate sequences mathematically equivalent to the identity operator by which a canary qubit can be measured for a state change, in accordance with various example embodiments and implementations of the subject disclosure.

FIG. 7B is a block diagram showing some interacting components of an example adaptive canary qubit system, in accordance with various example embodiments and implementations of the subject disclosure.

FIGS. 8 and 9 comprise a flow diagram showing example operations related to real-time qubit state error monitoring using adaptive assignment of canary qubits, in accordance with various example embodiments and implementations of the subject disclosure.

FIG. 10 is a flow diagram showing example operations related to determining hotspot regions in a quantum processing unit, determining that a canary qubit in a hotspot is in an error state, and reassigning an active logical qubit from that hotpot region to a non-hotspot region, in accordance with various example embodiments and implementations of the subject disclosure.

FIG. 11 is a flow diagram showing example operations related to determining hotspot and non-hotspot regions in a quantum processing unit based on telemetry data, and based on measuring a canary qubit's state in a first, hotspot region, reassigning an active logical qubit from that hotpot region to a second, non-hotspot region, in accordance with various example embodiments and implementations of the subject disclosure.

### DETAILED DESCRIPTION

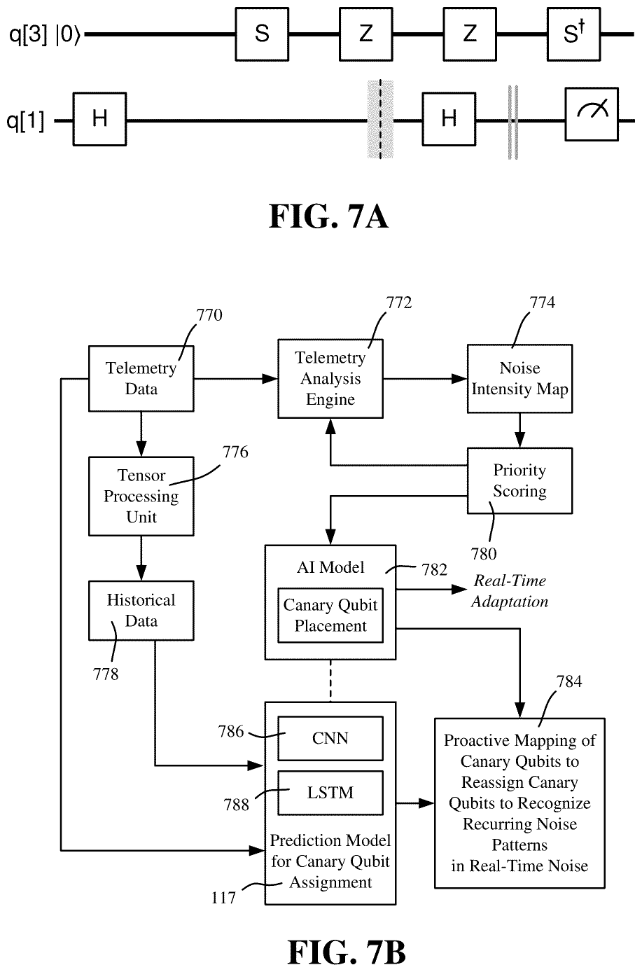

The technologies described herein are generally directed to quantum processing in which extra, otherwise unused physical qubits, referred to herein as “canary” qubits (with the term “canary” based upon the “canary in the coal mine” warning indicator) are used for determining whether some form of decoherence or noise likely affected active qubits being used for execution of process. That is, while active qubits are those used to process data, some number of otherwise unused qubits (from one to all) have a sequence of identity-operator gates applied to them that theoretically should result in an unchanged (e.g., “zero”) state (e.g., FIG. 7A).

An adaptive canary qubit system assigns canary qubits to different regions of a quantum processing unit, with a noise map determined based on collected telemetry data to determine and rank noisy regions as “hotspot” regions in the quantum processing unit. The canary qubits can be assigned based on artificial intelligence (AI)-driven prediction, based on historical data and prior results. On measurement, the adaptive canary qubit system checks the value of the canary qubits (particularly) in hotspot regions; in the event one or more of them evaluate to an error (e.g., “one”) state, the adaptive canary qubit system deduces that some form of decoherence or noise likely affected the quantum processing unit in the hotspot region. An active logical qubit operating in that hotspot is then reassigned to a less noisy, non-hotspot region.

Note that a drawback of conventional quantum processing units is that there is usually not a rightsized processor available for a given job. A user is forced to choose among a limited set of quantum processing units that have certain capacities, which are usually not dynamically split for multiple workloads, which leads to significant underutilization. This results in challenges, including noise variability and underutilized resources. Noise variability refers to noise not being uniformly distributed across the quantum processing unit; noise varies by region and fluctuates over time. With respect to underutilized resources, quantum processing units often operate with extra qubits left unassigned during tasks, missing an opportunity for proactive error detection as described herein.

Described herein is a hardware-integrated solution for an adaptive canary qubit system. The adaptive canary qubit system combines telemetry data with AI-driven predictive model(s) to dynamically assign and manage canary qubits. The canary qubit is system enables real-time detection of noise “hotspots” and refines logical qubit assignments to avoid high-noise regions. The system provides feedback to classical control hardware for targeted environmental adjustments. Indeed, the use of real-time environmental feedback on observed noise, obtained by the control hardware as described herein, helps to mitigate the causes of noise and prolong qubit coherence times.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

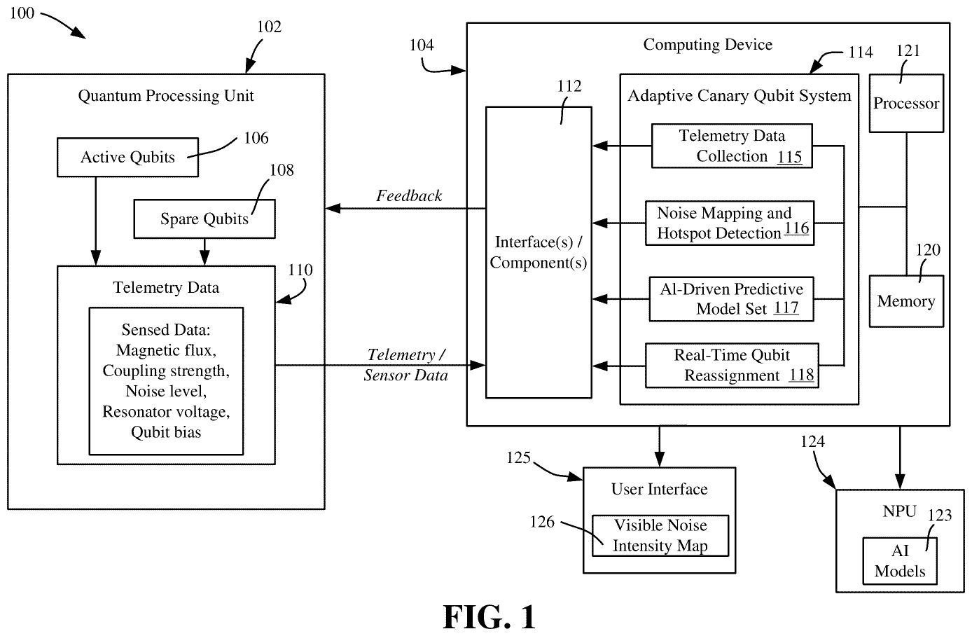

FIG. 1 is a representation of an example system 100 including a quantum processing unit 102 coupled to a computing device 104 such as a classical computer (wherein in general, classical computer refers to a commercially available, non-quantum computer system, e.g., server or server cluster, which can be or can include an edge computing device). In general, the quantum processing unit 102 includes one or more active qubits 106 (e.g., quantum gates, qubit state setting and the like) and one or more spare qubits 108. Active qubits are those that are used for executing a quantum process, whereas spare qubits are those that are otherwise unused for in the execution of the quantum process. Note that typically a quantum computer has many qubits, many of which are spare qubits.

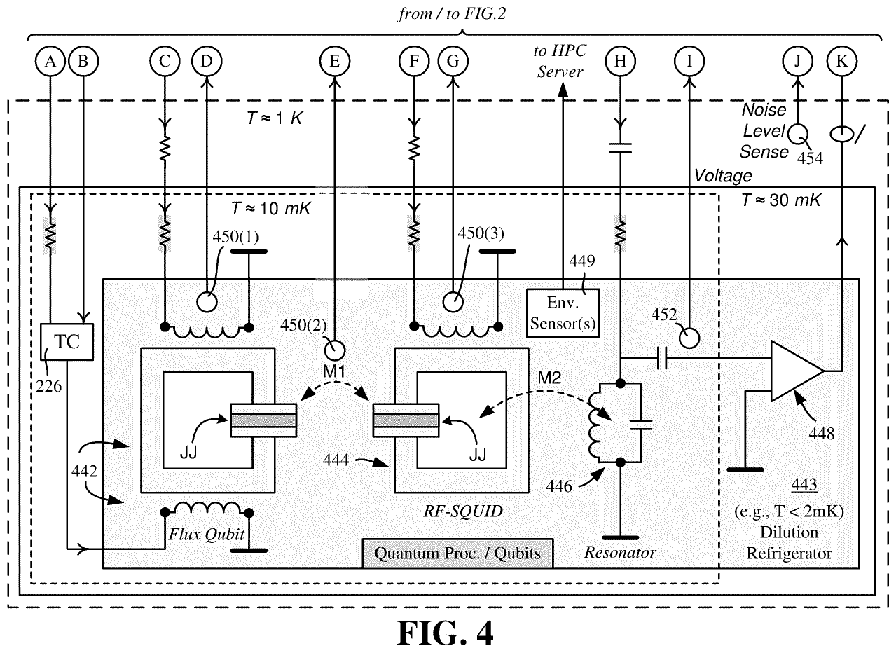

Sensors such as one or more radio frequency superconducting quantum interference device (rf-SQUIDs), temperature sensor(s), noise sensor(s) and so on gather telemetry data 110 related to the quantum processing unit 102, including respective telemetry data for respective different regions of the quantum processing unit 102. The sensed telemetry data 110 can include, but is not limited to, magnetic flux data, coupling strength data, noise level data, resonator voltage data, qubit bias data, and/or temperature data. The telemetry data 110 is coupled to the computing device 104, e.g., through one or more suitable interfaces and/or components 112, such as an analog-to-digital converter. Example telemetry data can include:
Magnetic flux at the qubit bias control. Monitoring magnetic flux helps maintain optimal qubit bias, for stable operation and accurate measurements. Real-time adjustments ensure the qubit remains within the desired operating range, reducing errors and improving coherence.
Mutual coupling strength between the qubit and the rf-SQUID. Accurate measurement of coupling strength is used for efficient qubit-resonator interactions; timely adjustment of coupling strength based on feedback enhances qubit readout precision.
The level of voltage at the output of the resonator/LC tank circuit. Maintaining the appropriate voltage level reduces signal distortion.
The noise level in the readout signal after it has been amplified. Real-time noise monitoring and adjustment lower the noise floor and improve the signal-to-noise ratio.
Temperature (env. sensor(s) block 449, FIG. 4), which can also sense humidity, electromatic radiation and so on), and/or microwave photons' power level can be sensed at each stage in the dilution refrigerator. Efficient use of resources, such as power and cooling, can be achieved through real-time adjustments, allowing for larger systems to be managed effectively.
Analog voltage/current coupled to the rf-SQUID that determines whether the rf-SQUID operates in the hysteresis or non-hysteresis mode.

One example implementation of a canary qubit system 114 is shown in FIG. 1, which includes functional modules 115-118. The canary qubit system 114 can be loaded in a memory 120 and executed, at least in part, by a processor 121. Example functional modules can include, but are not limited to, a telemetry acquisition module 115 that continuously (or near-continuously) monitors and analyzes quantum system data from sensors. Another component performs noise mapping and hotspot detection 116, e.g., described with reference to FIGS. 7-9. An AI-driven predictive model set 117 (one or more models), e.g., running as one or more AI models 123 on a neural processing unit (NPU) 124, analyze the telemetry data predict qubit errors, noise, and the like, including to proactively determine placement (select spare qubits as) canary qubits in likely noisy regions.

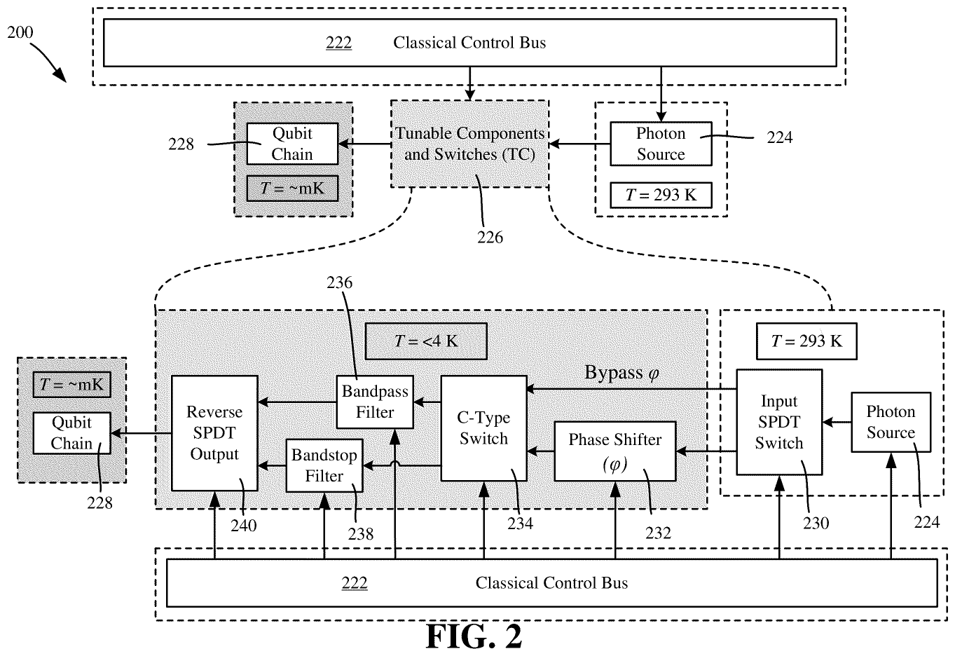

Turning to one example usage scenario, FIG. 2 is a generalized representation of an example hybrid classical-quantum system 200 that includes a classical control bus 222 (coupled to a classical computing device, e.g., 104, FIG. 1) and a quantum circuit in which a photon source 224, tunable components and switches (TC) 226 and qubit chain 228 interact with the benefit of intermediate tunable components 226 as described herein. Note that the tunable components 226 make the qubits less vulnerable to noise, thermal drift, or other forms of signal degradation; indeed, such signal issues can lead to errors in qubit manipulation, reducing gate fidelity. Feedback from the adaptive canary qubit system can tune the tunable components 226.

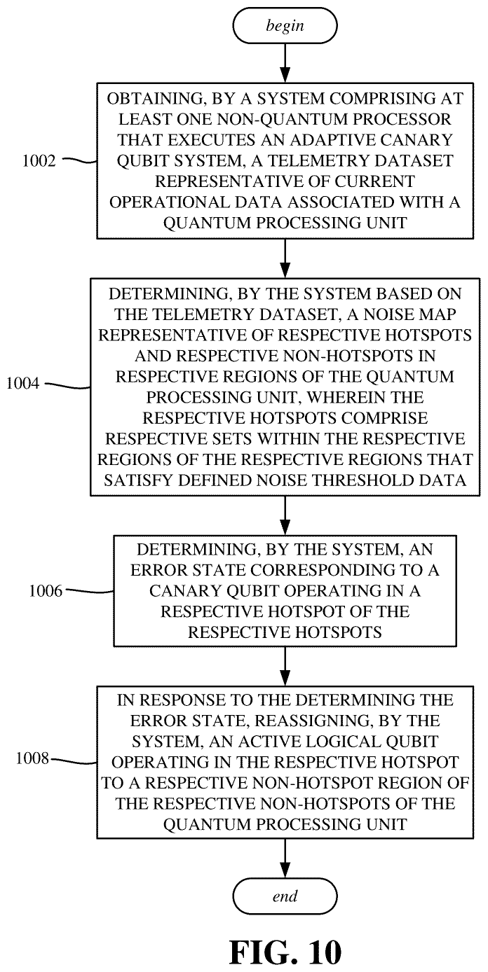

The photon source 224 generates the microwave signals used to manipulate qubits, as controlled by the computing device (the control bus 222 of which is shown in FIG. 10); the temperature at this stage is room temperature (e.g., around 293 K). The tunable components and switches 226 include an input single-pole, double throw (SPDT) switch 230 controlled via the classical control bus 222 to either bypass a phase shifter or shift the phase of the microwave signal via a phase shifter 232 that operates at cryogenic temperatures (below 4 K in this example). The phase shifter 232, if switched in, adjusts the phase of the microwave signals before they interact with the qubits of the qubit chain 228; the phase shifter may be a tunable device. The placement at cryogenic temperatures helps reduce phase drift caused by thermal noise.

A controlled C-type switch 234 selects a tunable (via the control bus 222) bandpass filter 236 and/or a bandstop filter 238. A reverse SPDT switch 230 couples the filtered signal to the qubit chain 228.

The qubit chain 228 includes qubits that are maintained at extremely low temperatures (millikelvin range) to ensure their stability/coherence during quantum gate operations. The signals from the photon source 224 interact directly with the qubits, manipulating their quantum states. After interacting with the qubits, the signal can be amplified, and measured (e.g., at room temperature); the amplified and measured signals are processed at room temperature by the classical computing device, such as to adjust the phase shifter and/or filtering to correct for phase noise, frequency noise, and so on to maintain qubit coherence.

In general, the integration of the classical computing device (control node) 104, including the canary qubit system 114 (FIG. 1) can monitor the signals in real time, to detect any noise errors or deviations that arise due to external environmental factors or hardware imperfections. Because quantum gate operations are extremely sensitive to such noise-related variations, the classical computing device compares the incoming signals as measured and flags any discrepancies from what the signal should be without noise errors or the like. Upon detecting deviations, the control node dynamically adjusts the tunable components to correct the next signal before it interacts with the qubit chain, thereby minimizing the impact of noise on qubit operations.

Note that temperature control can be a significant part of the quantum portion of the system, as different components operate at significantly different temperature levels to minimize noise and maintain coherence. The quantum processor operates at extremely low temperatures, with the qubit chain at 10 mK or below, and the signal amplifier at 30 mK. These temperatures maintain superconductivity and prevent thermal noise from disrupting the delicate quantum states. The flux sensing and control lines that interact with the qubits are also cooled down to 1 K to ensure minimal noise and stable control of the quantum operations. The classical control components, such as the microwave photon source, SMU, ADC, DAC, and HPC cluster, operate at room temperature (around 293 K). These components handle the classical data processing and control signals that drive the quantum system.

Via the tunable signal control and classical monitoring feedback loop, the system effectively mitigates noise, ensuring that the signals interacting with the qubits are phase-aligned and coherent throughout the gate operations. In some implementations, the tunable filter components 226 (FIG. 2) are located at cryogenic temperatures; the cryogenic placement of the tunable components 226 minimizes thermal noise and drift, further enhancing the system's ability to maintain coherence. The combination of real-time control and error monitoring by the classical node 104/canary qubit system 114 ensures that qubits remain stable during computation, resulting in higher-fidelity quantum gate operations and improved overall performance of the quantum system. The technology described herein thus overcomes a significant challenge in quantum computing, namely preserving qubit coherence and reducing errors during quantum operations.

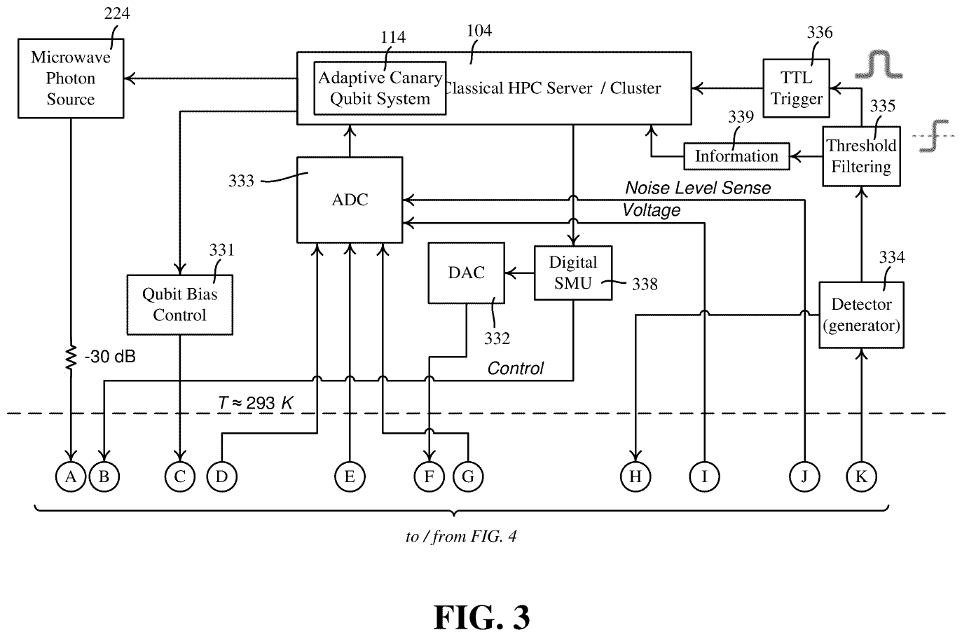

FIGS. 3 and 4 comprise a block diagram representation of an example quantum processor measurement and control setup/environment, in which qubit control and readout is facilitated by integrating a classical high-performance computing server/cluster 104 and the adaptive canary qubit system (FIG. 1) with a quantum computing system having a quantum processor and qubits 442 (FIG. 4) near the base plate of a dilution refrigerator 443, on the order of 2 milli-Kelvin (mK).

The representation of FIG. 4 thus shows an example architecture of a quantum system with a focus on cryogenic control and signal processing. The overall system 200 (e.g., summarized in FIG. 2) integrates classical control components (FIG. 3) and quantum hardware (FIG. 4) to ensure the proper manipulation and measurement of qubits, with an emphasis on temperature management to maintain the coherence of quantum operations. As generally shown in FIG. 4, the quantum hardware is housed within the dilution refrigerator 443, ensuring ultra-low temperatures for stable qubit operations. In one implementation, the quantum portion (FIG. 4) of the hybrid system 200 (FIG. 2) operates with a combination of flux qubits, RF-SQUIDs (radio frequency-superconducting quantum interference devices), and a resonator, each contributing to the manipulation and control of quantum states.

In general, a flux qubit is a type of qubit that operates based on superconducting loops in which the current can circulate in both clockwise and counterclockwise directions, representing quantum superposition. The qubit (e.g., 442) is housed at a temperature of 10 mK or below (e.g., 2-4 mK), which helps maintain coherences and prevent decoherence due to thermal noise.

The RF-SQUIDs are superconducting circuits used to control the coupling between qubits. The RF-SQUIDs allow manipulation of quantum states by providing a tunable inductive coupling between the qubits. The Josephson junctions (JJ) in the RF-SQUIDs enable quantum tunneling, which is a core part of quantum operations in superconducting qubits. The magnetic interaction between the RF-SQUIDs (represented by M1), and between the RF-SQUID 444 and the resonator 446 (represented by M2), can adjust the energy levels and state transitions of the qubits.

The resonator 446 is coupled to the qubits, providing a device to read out the qubit states. By measuring the resonance frequency shifts, the state of the qubits can be inferred, allowing for quantum state measurements. After interacting with the qubits, the signal is passed through a cryogenic amplifier 448, e.g., operating at around 30 mK. Amplifying the signal in such a low-temperature environment ensures that noise is kept to a minimum before the signal is sent for classical processing. The amplifier 448 helps to boost the weak quantum signals for subsequent measurement without introducing significant noise that could affect accuracy.

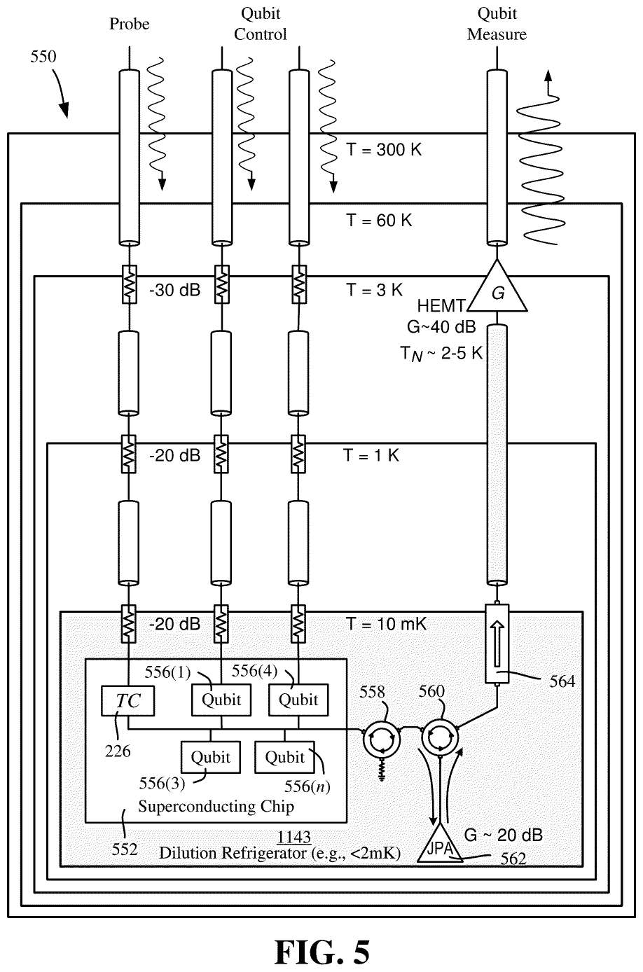

FIG. 4 also shows flux/coupling strength sensors 450(1)-450(3) and a voltage sensor 452. The environmental sensors 449 are shown in FIG. 4 as being in the dilution refrigerator 443, but it is understood that the environmental sensors 449 can be deployed at various temperature stages of the quantum system (e.g., such stages are shown in FIG. 5).

As shown in FIG. 3, the example classical (non-quantum) portion of the hybrid system 200 (FIG. 2) includes the microwave photon source 224, which is controlled by the classical high-performance compute (HPC) server/cluster 104, both operating at room temperature (around 293 K). As described herein, the classical system portion interfaces with the quantum hardware to drive, control, and measure qubit operations. M ore particularly and as will be understood, the canary qubit system 114 in the server/cluster 104 processes the data from the quantum hardware, including measurements from the qubits, and can also provide real-time feedback for qubit control, adjusting the parameters, including the tunable components 226, based on the measured outcomes to optimize the quantum operations.

The microwave photon source 224 generates microwave signals that interact with the qubits. The microwave source 224 feeds microwave signals through coaxial cables into the quantum hardware. The microwave signals are controlled to ensure precise phase, amplitude, and timing, as is appropriate for quantum gate operations. The microwave photons from the microwave photon source 226 go through multiple temperature stages to reach the flux qubits (e.g., 442) in the dilution refrigerator 443.

At each stage, along with the reducing temperature, the microwave signal is heavily attenuated as qubits are provided very low-power microwave photons. Note that the HPC server/cluster 104 can control operation of the photon source 224 in terms of pulses, e.g., the sequence of pulses, the width and voltage of the pulses and the like can be controlled by the classical server/cluster 104; any amount of gates can be applied to the qubit, to control the qubit and configure the qubit, including as described herein.

A qubit bias control component (block 331, FIG. 3) provides precise magnetic flux control to the qubits. Adjusting the magnetic flux through the superconducting loops enables the fine-tuning of the qubit states. This control system operates at room temperature but communicates with the cryogenic quantum hardware through superconducting lines. The qubit bias control can be in the form of a constant voltage or current to adjust the energy levels of the qubit, and can be provided from the canary qubit system 114 in the server/cluster 104. A change in the magnetic flux in the qubit 442 (FIG. 4, after absorption of a photon) induces a change in the mutual flux coupling (M1) with an RF-SQUID M2, which in general acts as a detector controlled by the canary qubit system 114 in the server/cluster 104, e.g., via a digital-to-analog converter (DAC) 332. The RF-SQUID 444 includes a superconducting loop across a Josephson Junction (JJ) characterized by its critical current (IC), capacitance (C), and shunt resistance (R).

Note that in general, the digital-to-analog converter 332 along with an analog-to-digital converter (ADC) 333 translates between the digital signals used for classical computation and the analog signals used in the quantum hardware. The DAC 332 generates precise analog control signals for driving qubit operations, while the ADC 333 digitizes the analog signals received from the qubit measurement. These converters operate at room temperature in this example.

To register signals in RF-SQUIDs, a readout resonator/LC (inductor-capacitor) tank circuit 446 (FIG. 4) is used, including an inductor (L_{T}) and a capacitor (C_{T}), which together oscillate at a natural frequency ω_{T}/2 π=\sqrt{1}/2π/(L_{T}−C_{T}). The resonator 446 is designed to be sensitive to small changes in magnetic flux, mutually coupled (M2) to the RF-SQUID 444, as appropriate for detecting photon interactions with the qubit. An external pumping current I_{rf} sin (ω_{P}t) is provided (via labeled circle “G”) from a detector/generator 334 (FIG. 3) at frequency Ω/2π, which is very close to the natural frequency of the LC tank circuit resonator 1296 (ω_{P}−ωₜ)/T<<1 and quality factor Q>>1. The current/voltage bias to the RF-SQUID 444 is very accurate so as not to (inadvertently) operate the RF-SQUID's M2 in non-hysteresis mode.

Note that FIG. 4 only shows components for two RF-SQUIDS/qubits, however any practical number may be present in a given quantum computing configuration. Further note that the resonator 446 can obtain a control signal, and because any voltage generates the magnetic flux, a qubit state change will occur, as the generated magnetic flux will break the entanglement, or it will collapse the qubit; the system can read that what was the recent data, such as how much frequency changed in the resonator 446.

The output from the LC tank/resonator 446 is very weak, and hence is amplified (signal amplifier 448) and provided to the detector 334 (FIG. 3), which further performs threshold filtering (block 335) to quantize the state of the qubit, and provides the transistor-transistor logic (TTL) trigger (block 336) to the classical server/cluster 104. In general, threshold filtering component, block 335, along with the detector 334, are part of the classical control system and fed to the PCIe interface, and are responsible for analyzing the output from the quantum hardware. The signals are passed through the threshold filter335 to remove noise and isolate the meaningful quantum information. The detector 334 then extracts the final measurement results from the filtered signals. The TTL trigger 336 is used for synchronizing operations within the classical system and with the quantum hardware. Precise timing of signals is used in quantum systems, and the TTL trigger 336 ensures that operations such as qubit state initialization, manipulation, and readout are synchronized.

To ensure accurate control, a PCIe card interface-based digital source measure unit (SM U) 338 can be used, such as a high-performance SM U that is commercially available. In general, a digital source measure unit (SM U) 338 provides precise voltage or current control for various elements in the quantum system. The SM U 338 ensures that bias voltages and other control parameters are stable, which maintains qubit fidelity. A high-performance PXI-based SMU (PCI eX tensions for Instrumentation) provides fast, precise dynamic measurements from DC to a 20 μs pulse, with outputs up to 210 V/315 mA, 10 femtoampere (fA) resolution, and the lowest source noise.

Similarly, a commercially available PX I-based digital-to-analog converter (DA C) 332 can be used, such as one that features sixteen simultaneous channels capable of supplying stimulus waveforms with output voltages ranging from OV to +30V, and output currents from 0 mA to +20 mA. In one implementation, both the SM U 338 and DAC 332 are compatible with PCIe interfaces and can be housed in a PXI chassis, which saves rack space and reduces maintenance cost. Also shown in FIG. 3 is the analog-to-digital converter (ADC) 333 coupled to the classical server/cluster 104 and to a number of sensors (450(1)-450(3), 452 and 454, the small circles at various tap points in FIG. 4, corresponding to the circled labels D, E, G, I and J).

To summarize, in one example implementation, the digital SM U 338 can control tunable components 226 (FIGS. 2-4) that can apply an adjusted microwave signal to a qubit. Feedback information (block 339, FIG. 3) can be provided to the classical canary qubit system 114 of the server/cluster 104. Such feedback information allows real-time tuning and repeated measurements to ensure accurate quantum state tracking and error correction, e.g., if small deviations are detected between the applied signal and the measured signal following execution of one or more operations on the qubit as described herein, the signal can be adjusted and the operations reattempted and remeasured.

Thus, as generally represented in FIG. 3, hardware for control and readout can, for example, include one or more advanced source measure units (SM Us) and analog-to-digital converters (ADCs), which can be managed more efficiently with classical systems, thereby reducing the number of physical components and vendor equipment otherwise needed. Such a hybrid system can be designed modularly, where each module, including multiple qubits and their respective control/readout lines, can be independently managed by one or more classical processors. Such modularity simplifies system scaling, allowing new modules to be added without redesigning the entire control infrastructure.

The technology described herein leverages the precise classical control of the qubit control and measurement operations. For example, a classical high-performance computing server (or cluster of such servers) with peripheral component interconnect express (PCIe-based) or the like control can use a source measure unit (SM U) for quantum computers with some practical number (e.g., one the order of dozens) of qubits, including to apply controlled phase shift, controlled bandpass filtering, and controlled rotation to a qubit.

Further, the technology described herein controls the qubit readout circuit using a source measure unit and digital-to-analog converter; this can provide ultra-precise control of readouts with ultra-low signals. The hybrid classical-quantum technology described herein is, in part, directed to recording a photon-induced transition in a flux qubit, for example. Note however that photons/flux qubits are only examples, as indeed, the technology described herein is agnostic to any particular type of qubit, and further, that probe signals other than those based on microwave photons can be used, as appropriate for a given type of qubit.

Further, in one or more example implementations, one or more of the tunable components 226 can be designed and monolithically integrated with a superconducting chip that integrates the qubits. FIG. 5 is a block diagram representation of an example quantum processor measurement and control setup/system 550 including a measurement and control setup for a superconducting quantum computing chip 552 near the base plate of a dilution refrigerator 553, on the order of 2-10 Kelvin (mK). Some number of qubits 556(1)-556 (n) (four are depicted, but any practical number may be present) are fabricated on the superconducting quantum computing chip 552, along with a monolithically integrated set of the tunable components 226. Note that one or all of the other tunable components 226 (FIG. 2, including the phase shifter 232, the bandpass filter 236 and/or bandstop filter 238) also can be similarly fabricated on the superconducting quantum computing chip 552.

Also shown in FIG. 5 as part of the qubit measuring portion are circulators 558 and 560, a Josephson parametric amplifier (JPA) 562, an isolator 564 and a high electron mobility transistor (HEM T) G. In general, a probe signal that is a set of strongly attenuated microwave tones (<−120 dBm) is by injected via coaxial cables (depicted as unshaded cylinders) and attenuators to the qubits 556(1)-556 (n) through the various levels of the quantum processor system 550, resulting in a measurement signal being input via a readout line to a first port of the circulator 558. As described herein, the circulator 558 is configured for clockwise rotation, whereby the signal is routed to a second port (low insertion loss) and not the third port (high isolation, and coupled via resistor to ground), nor returned to the first port (low return loss). The second port is coupled to the input port of a second circulator 560 configured for counterclockwise rotation, such that the signal is routed to at least one Josephson parametric amplifier (JPA) 562, with the amplified measurement signal routed back to the output port of the circulator 560 though the isolator 564 to the HEMT G for further gain before measurement by one or more conventional RF devices (not explicitly shown). Note that the shaded cylinder shown in the measurement signal output path represents a superconducting coaxial cable. Based on the measurement results, qubit control signals can be sent to the qubits 556(1)-556(n).

Thus, each circulator is a nonreciprocal three-port device that allows signals to travel in only one predetermined direction among its three ports, whereby the qubit readout line uses such circulators 558 and 560 to provide isolation between different components so as to maintain the fidelity of the qubit readout. By isolating different parts of the readout circuit, circulators help in reducing noise that could otherwise affect the qubit's state and/or the accuracy of the readout. Multiple circulators are used in the quantum computing setup, ensuring that signals are correctly channeled to the appropriate destinations as shown in FIG. 5.

To summarize FIG. 5, the state of the superconducting qubits is probed, and the readout involves amplifying and delivering the measured result back to room temperature. The weak output signal from a qubit is amplified using one or more superconducting parametric amplifiers, such as Josephson parametric amplifiers (JPA), operating at 10 mK and semiconductor high electron mobility transistor (HEMT) amplifiers operating at 4 K. The RF circulators are used to protect the quantum circuit from reflections and noise; the probing, control, and readout of qubit systems involves a large amount of microwave hardware.

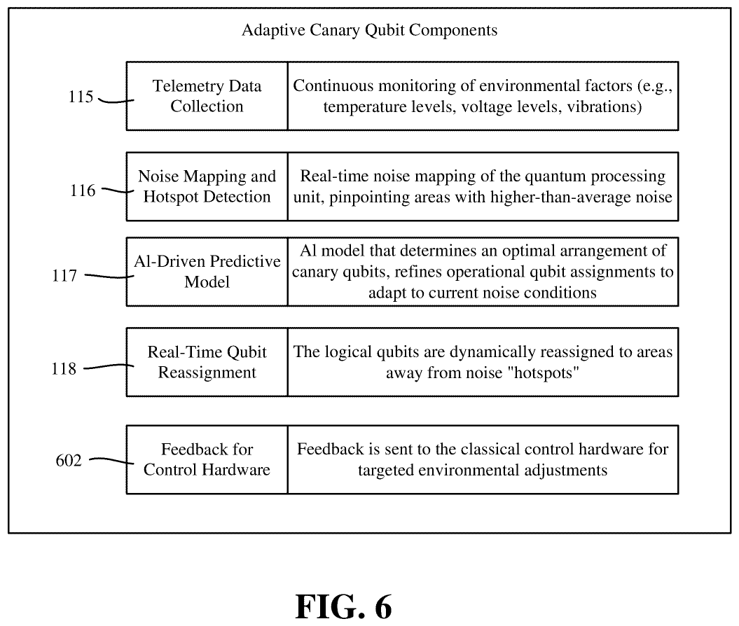

Turning to operations of the adaptive canary qubit system 114 for real-time error management (including via proactive actions) in quantum processing units as described with reference to FIG. 1, the adaptive canary qubit system for real-time error management in quantum processing units includes telemetry data collection 115, also summarized in FIG. 6. As described herein with reference to FIGS. 2-4, the quantum system includes an array of sensors at multiple locations to continuously (or near-continuously) monitor factors like temperature, flux, voltage levels, that are known to impact qubit performance if not managed. A processing unit, which can be a dedicated processing unit such as an edge computing device or a classical computing server/cluster as in FIG. 1, receives a stream of data from these sensors. The processing unit, can, for example, organize raw data, filter out redundant information and perform data normalization. Outliers can be flagged, for example to pass high-quality data to the noise mapping component 116.

FIG. 6 shows some details of the example components 115-118 of the adaptive canary qubit system 114, including the telemetry data collection component 115, which performs continuous (or near-continuous) monitoring of environmental factors (e.g., temperature levels, voltage levels, vibrations and so on). The noise mapping and hotspot detection component 116 performs real-time noise mapping of the quantum processing unit, pinpointing areas with higher-than-average noise. The AI-driven predictive model 117 determines an optimal arrangement of canary qubits, and refines operational qubit assignments to adapt to current noise conditions. The real-time qubit reassignment component 118 dynamically reassigns logical qubits to areas away from “hotspots” as described herein. Also shown in FIG. 6 is the feedback for the control hardware (block 602), representing that feedback is sent to the classical control hardware for targeted environmental adjustments.

A canary qubit, such as an unused qubit selected within a hotspot region, can have its state measured, in which a gate sequence is applied to the canary qubit, such as shown in FIG. 7A. There is an expected state measurement based on the state of the qubit before application of the gate sequence. Thus, if the canary qubit is in the zero state and a sequency of gates corresponding to an identity operator is applied, the canary qubit should remain in the zero state. If the canary qubit instead measures as being in an error state (a “one” state in this example), the adaptive canary qubit system deduces that some form of decoherence or noise likely affected the quantum processing unit in that hotspot region. Logical active qubits operating in that hotspot region are reassigned to another non-hotspot region.

With respect to hotspot detection and a noise mapping system, as shown in FIG. 7B, a telemetry analysis engine 772 continuously integrates telemetry data 770 to create a noise intensity map 774, visualizing high-noise and low-noise regions across the quantum processing unit. In general, noise regions on a quantum processing unit refer to areas within a quantum processor where qubits are more susceptible to errors, e.g., resulting from environmental noise, detected via the current telemetry data 770; different qubits within the quantum processing unit may have different noise characteristics.

The telemetry analysis engine 772 sets noise thresholds for each environmental factor based on prior data trends; if the noise in a region surpasses these thresholds, the region is marked as a “hotspot.” For a version that operators can visualize, as shown in FIG. 1 via a user interface 125 and block 126, a visible representation of the noise map can be generated with color-coded areas showing different noise intensities, for example, allowing operators to see the current status of the quantum system at a glance.

The noise map 774 is updated in real-time, allowing the system to monitor the distribution of noise as environmental conditions change. In addition to real-time data, a tensor processing unit 776 stores historical data 776, including patterns of temperature fluctuations and prior noise events/which can include prior canary qubit measurement results. The historical data 776 allows for trend recognition and is used by the AI-driven prediction model 117 to improve accuracy in detecting noise patterns and forecasting hotspots.

Priority scoring (block 780) is performed on hotspots. In one implementation, hotspots are scored based on noise intensity and proximity to active qubits, helping an artificial intelligence (AI) model 782 prioritize high-risk areas for canary qubit placement. The telemetry analysis engine 772 (e.g., continually) refines the priority and location of hotspots, ensuring that the canary system adapts to the current environment.

The canary qubit system also includes proactive mapping (block 784) of canary qubits, in which the real-time noise is correlated with historical data, recognizing recurring noise patterns. If the system (the AI driven prediction model 117) detects patterns that previously led to decoherence, (e.g., temperature rises in specific regions), the system can proactively signal the prediction model to reassign canary qubits. Such proactive detection helps the system mitigate potential issues before they disrupt quantum operations.

Thus, in one implementation a part of the adaptive canary qubit system 114 is AI-driven prediction for canary qubit assignment, in which a robust AI-driven prediction model 117 for canary qubit assignment uses a combined approach of convolutional neural networks (CNN) and long short-term memory (LSTM) layers. This facilitates a more comprehensive solution for capturing both spatial (noise distribution across the quantum processing unit) and temporal (how noise changes over time) patterns. The combined approach allows a CNN 786 to learn spatial patterns effectively, and can potentially handle short-term temporal dependencies by applying temporal convolutions across time frames. Note that CNNs are limited in capturing long-term dependencies over a large number of time steps. Adding the LSTM layer 788 enables the model to capture long-term temporal dependencies. Noise patterns in quantum processing units have trends or recurring patterns over longer periods, which an LSTM tends to learn better than a CNN alone.

The noise levels across the quantum processing unit at different qubit locations are recorded over time and the data is represented as a sequence of 2D matrices (called heatmaps) where each matrix corresponds to the noise distribution at a specific time step. Let X∈R^{T×M×N}, where T is the number of time steps, and M×N are the spatial dimensions of the quantum processing unit. The convolutional layers extract spatial features from each 2D noise heatmap. For each time step t, the input X(t)∈R^{M×N} is passed through multiple convolutional layers. The equation for the output F^{(p)} from a convolutional layer p is:

F^{(p)}=f(w^{(p)}*X^{(p-1)}+b^{(p)}).

In this equation, w^{(p)} is the filter matrix at layer p, b^{(p)} is the bias, and f(·) is ReLU (rectified linear unit) activation function for CNNs. These convolutional layers detect patterns such as localized noise clusters (hotspots), creating a feature map that captures spatial dependencies.

After each convolutional layer, a pooling layer is applied as a down sampling operation to reduce the spatial dimensions of the feature map output by the convolutional layers, lowering the computational load in subsequent layers. M ax pooling can be used to select the maximum value in a defined window within the feature map, effectively capturing the highest feature value in that window. High-noise regions (hotspots) have higher activation values in the feature map; this highlights areas with strong noise signals while discarding smaller, less relevant fluctuations.

After the pooling layer, the LSTM layer 788 can be used, which learns long-term dependencies in noise patterns over time. The LSTM layer 788 takes the sequence of feature maps {F⁽¹⁾, F⁽²⁾, . . . , F^{(T)}} as input and processes them sequentially.

For this operation, the LSTM layer uses the following equations for each time step t:

iₜ=σ(WᵢF^{(t)}+Uᵢhₜ₋₁+bᵢ)

fₜ=σ(W_{f}F^{(t)}+U_{f}hₜ₋₁+b_{f})

oₜ=σ(WₒF^{(t)}+Uₒhₜ₋₁+bₒ)

[symbol]

=tanh(W_{c}F^{(t)}+U_{c}hₜ₋₁+b_{c})

cₜ=fₜ⊙cₜ₋₁+iₜ⊙

[symbol]

hₜ+=iₜ⊙tanh(cₜ).

In the above equations, iₜ, fₜ, oₜ are the input, forget, and output gates, respectively, while σ denotes the sigmoid function, cₜ is the cell state, and hₜ is the hidden state output.

The LSTM layer 788 outputs a hidden state hₜ at each time step, capturing temporal dependencies in noise patterns. The sequence of hidden states from the LSTM layer 788 are passed through fully connected layers to output a prediction. The prediction can be a binary classification (hotspot or non-hotspot) for each qubit region, or a probability map indicating the likelihood of each region being a hotspot, for example.

Followed by the output prediction, a loss function is used to allow the CNN-LSTM model to learn from its mistakes. The loss function provides a quantitative measure of the model's error, enabling the model to learn by minimizing this error through weight adjustments. The following loss function can be used to adjust weights, gradually improving its accuracy in predicting noise hotspots; the cross-entropy loss function can be for classification:

$$L = - {\sum }_{i} {y}_{i} log ( \text{?} ) ,$$

where yᵢ is the true label (0 or 1 for hotspot/non-hotspot), and [symbol] is the predicted probability.

For regression (predicting noise level), mean squared error (MSE) can be used:

$$L = \frac{1}{N} {\sum }_{i = 1}^{N} {( {y}_{i} - \text{?} )}^{2}$$

This acts as a mechanism for model improvement and training to accurately detect noise patterns.

Decoherence detection, error localization and real-time logical qubit reassignment are facilitated. M ore particularly, canary qubits are put through sequences that should yield |0 [symbol] . Unexpected deviations, like a |1 [symbol] measurement, can indicate potential noise-induced errors. The system's middleware takes action directly, to dynamically reassign logical qubits away from noisy regions, in order to maintain computational fidelity and continuity. Logical qubits that handle more critical operations are prioritized for relocation, ensuring noise does not interfere with more essential quantum tasks. Errors detected by canary qubits are pinpointed to very exact locations, allowing the system to create a detailed map of noise-prone areas. In the map, different types of errors are categorized, allowing for tailored hardware responses.

With respect to feedback to control hardware, at the same time as when the above damage control is being performed, a feedback loop informs the classical control hardware of the affected regions, enabling the system to take virtually immediate corrective actions. The feedback system allows for targeted environmental modifications, such as adjusting temperature in specific areas, which helps extend qubit coherence times.

Via continuous model refinement, the model refines itself by integrating telemetry data and feedback from previous jobs, improving accuracy over time. Regular performance benchmarks help to ensure that model predictions align with actual noise events, allowing for calibration.

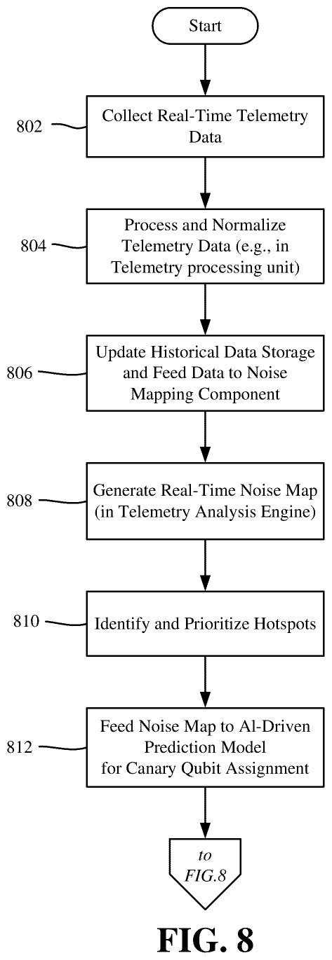

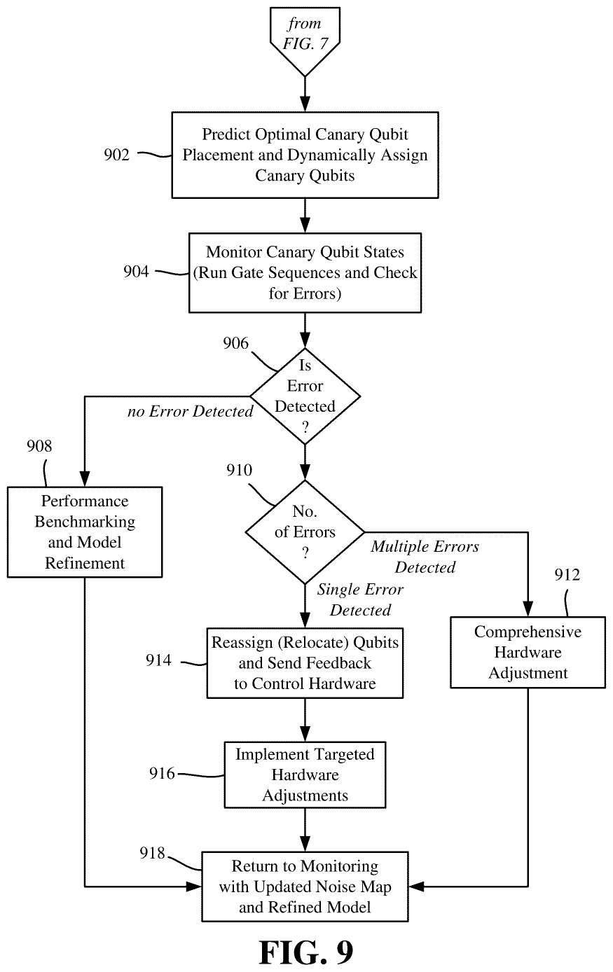

FIGS. 8 and 9 comprise a flow diagram showing example operations directed to real-time error monitoring using adaptive assignment of canary qubits. Operation 802 of FIG. 8 represents the adaptive canary qubit system collecting real-time telemetry data, and operation 804 represents processing and normalizing telemetry data, e.g., in a telemetry processing unit. Operation 806 represents updating the historical data storage and feeding the telemetry data to the noise mapping components.

Operation 808 generates a real-time noise map, e.g., in the telemetry analysis engine 772 of FIG. 7. Operation 810 represents identifying and prioritizing hotspots, while operation 812 feeds the noise map 774 to the AI-driven prediction model 117 for canary qubit assignment.

Operation 902 of FIG. 9 represents the prediction model predicting the optimal canary qubit placement, and dynamically assigning the canary qubits. Operation 904 represents monitoring the canary qubit states, by running gate sequences and checking for errors.

Operation 906 evaluates whether the monitoring detects errors; if no errors are detected, performance benchmarking and model refinement is performed at operation 908. Operation 910 takes actions depending on whether one error or multiple errors are detected. If multiple errors are detected, comprehensive hardware adjustments are performed via operation 912.

Otherwise, only a single error detected, whereby operation 914 reassigns the qubits and sends feedback to the control hardware, by which operation 916 implements targeted hardware adjustments. Whether zero, one or multiple errors are detected, operation 918 represents returning to the monitoring operations, with an updated noise map and refined model.

One or more example implementation described herein can be embodied in a system. The system can include a quantum processing unit comprising qubits, a computing device comprising at least one processor, and an adaptive canary qubit system configured to execute, at least in part, via the computing device, the adaptive canary qubit system coupled to the quantum processing unit. The adaptive canary qubit system is configured to obtain telemetry data from the quantum processing unit, the telemetry data comprising noise data, determine, from the noise data, a noise hotspot comprising a first region in the quantum processing unit that satisfies defined noise threshold data, assign a canary qubit of the qubits to the first region, measure state data of the canary qubit, and, in response to the state data being determined to correspond to an error state, relocate an active logical qubit of the qubits that can be operating in the first region to a second region that does not satisfy defined noise threshold data.

The adaptive canary qubit system can include a model set.

The model set can be executed via at least one neural processing unit.

The model set can predict the first region to which the canary qubit can be assigned.

The telemetry data can include current telemetry data, and the model set can predict the first region to which the canary qubit can be assigned based on the current telemetry data and historical telemetry data.

The model set can include at least one of: a convolutional neural network, or a long short-term memory layer.

The active logical qubit can be a respective first active logical qubit of respective active logical qubits, the noise hotspot can be a first respective noise hotspot of a group of respective noise hotspots, and the adaptive canary qubit system can be further configured to determine respective score data of the respective noise hotspots based on respective noise intensity data and respective proximities to the respective active qubits.

The telemetry data can be based at least in part on current environmental data in the quantum processing unit, and the adaptive canary qubit system can adaptively refine the respective score data as the environmental data changes over time.

The active logical qubit can be relocated from the first region to the second region based on the respective score data.

The adaptive canary qubit system can determine a noise map based on the respective score data of the respective noise hotspots.

The adaptive canary qubit system can apply a gate sequence to the canary qubit to measure the state data of the canary qubit.

One or more example implementations and embodiments, such as corresponding to example operations of a method, can be represented in FIG. 10. Example operation 1002 represents obtaining, by a system comprising at least one non-quantum processor that executes an adaptive canary qubit system, a telemetry dataset representative of current operational data associated with a quantum processing unit. Example operation 1004 represents determining, by the system based on the telemetry dataset, a noise map representative of respective hotspots and respective non-hotspots in respective regions of the quantum processing unit, wherein the respective hotspots can include respective sets within the respective regions of the respective regions that satisfy defined noise threshold data. Example operation 1006 represents determining, by the system, an error state corresponding to a canary qubit operating in a respective hotspot of the respective hotspots. Example operation 1008 represents, in response to the determining the error state, reassigning, by the system, an active logical qubit operating in the respective hotspot to a respective non-hotspot region of the respective non-hotspots of the quantum processing unit.

Further operations can include determining respective score data for the respective hotspots, and ranking the respective hotspots in a priority ordering.

The telemetry data can include current telemetry data, and further operations can include predicting, by the system, placement of the canary qubit in the respective hotspot of the respective hotspots based on the current telemetry data and historical telemetry data.

Further operations can include preprocessing, by the system, raw data collected from sensors deployed in the quantum processing unit, to obtain the telemetry data.

Determining the error state can include applying a gate sequence to the canary qubit, and measuring resulting state data of the canary qubit after the applying of the gate sequence, to determine that the resulting state data is in an incorrect state.

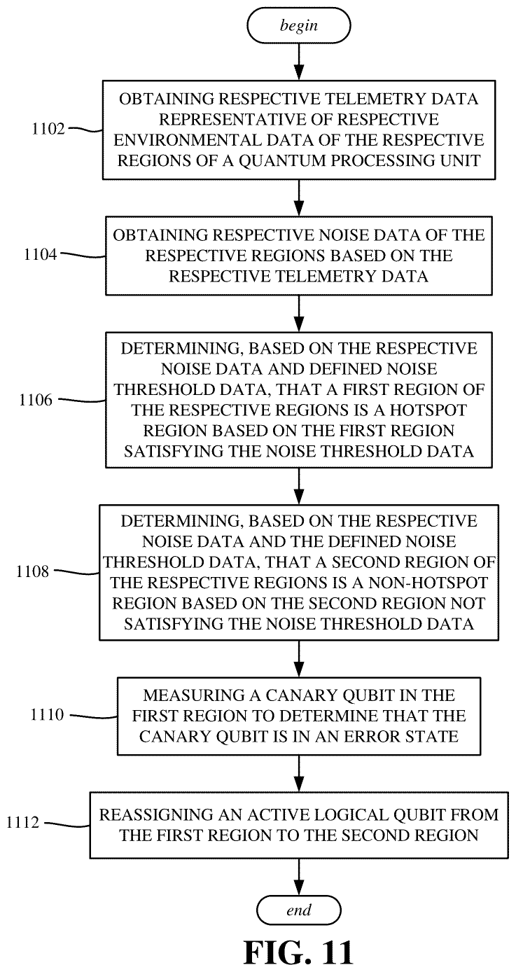

One or more concepts described herein can be embodied in a system, such as represented in the example operations of FIG. 11, and for example can include at least one memory that stores computer executable components and/or operations, and at least one processor that executes computer executable components and/or operations stored in the memory. Example operations can include operation1102, which represents obtaining respective telemetry data representative of respective environmental data of respective regions obtaining respective telemetry data representative of respective environmental data of respective regions of a quantum processing unit. Example operation 1104 represents obtaining respective noise data of the respective regions based on the respective telemetry data. Example operation 1106 represents determining, based on the respective noise data and defined noise threshold data, that a first region of the respective regions can be a hotspot region based on the first region satisfying the noise threshold data. Example operation 1108 represents determining, based on the respective noise data and the defined noise threshold data, that a second region of the respective regions can be a non-hotspot region based on the second region not satisfying the noise threshold data. Example operation 1110 represents measuring a canary qubit in the first region to determine that the canary qubit can be in an error state. Example operation 1112 represents reassigning an active logical qubit from the first region to the second region.

Further operations can include generating a heat map based on the respective noise data of the respective regions, determining respective priority scores of the respective regions based on the respective noise data, and ranking the respective regions based on the respective priority scores.

The telemetry data can include real-time telemetry data, and wherein the operations further can include predicting placement of the canary qubit in the first region based on the real-time telemetry data and historical telemetry data.

Measuring the canary qubit can include applying a gate sequence to the canary qubit to determine that the canary qubit can be in the error state based on the canary qubit not being in an expected state after the applying of the gate sequence.

As can be seen, the technology described herein can be directed to strategically assigning canary qubits based on real-time telemetry data and AI-predicted hotspots. The canary qubits can be assigned in regions where the model predictions have high uncertainty, which enhances the system's resilience to unpredictable situations. The adaptive canary qubit system collects real-time telemetry data from the quantum system and continuously feeds the telemetry data into the prediction models to help in an accurate, dynamic noise map of quantum processing unit. The adaptive canary qubit system includes a feedback mechanism by which detected errors from canary qubits trigger targeted hardware adjustments. Feedback can be sent to the control hardware to make localized changes, such as adjusting temperatures, voltage or power levels. This feedback-driven approach enables real-time, automated hardware response to detected noise hotspots.

The above description of illustrated embodiments of the subject disclosure, comprising what can be described in the Abstract, can be not intended to be exhaustive or to limit the disclosed embodiments to the precise forms disclosed. While specific embodiments and examples can be described herein for illustrative purposes, various modifications can be possible that can be considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a quantum processing unit comprising qubits;
a computing device comprising at least one processor;
an adaptive canary qubit system configured to execute, at least in part, via the computing device, the adaptive canary qubit system coupled to the quantum processing unit, and configured to:
obtain telemetry data from the quantum processing unit, the telemetry data comprising noise data;
determine, from the noise data, a noise hotspot comprising a first region in the quantum processing unit that satisfies defined noise threshold data;
assign a canary qubit of the qubits to the first region;
measure state data of the canary qubit; and
in response to the state data being determined to correspond to an error state, relocate an active logical qubit of the qubits that is operating in the first region to a second region that does not satisfy defined noise threshold data.

2. The system of claim 1, wherein the adaptive canary qubit system comprises a model set.

3. The system of claim 2, wherein the model set is executed via at least one neural processing unit.

4. The system of claim 2, wherein the model set predicts the first region to which the canary qubit is assigned.

5. The system of claim 2, wherein the telemetry data comprises current telemetry data, and wherein the model set predicts the first region to which the canary qubit is assigned based on the current telemetry data and historical telemetry data.

6. The system of claim 5, wherein the model set comprises at least one of: a convolutional neural network, or a long short-term memory layer.

7. The system of claim 1, wherein the active logical qubit is a respective first active logical qubit of respective active logical qubits, wherein the noise hotspot is a first respective noise hotspot of a group of respective noise hotspots, and wherein the adaptive canary qubit system is further configured to determine respective score data of the respective noise hotspots based on respective noise intensity data and respective proximities to the respective active qubits.

8. The system of claim 7, wherein the telemetry data is based at least in part on current environmental data in the quantum processing unit, and wherein the adaptive canary qubit system adaptively refines the respective score data as the environmental data changes over time.

9. The system of claim 7, wherein the active logical qubit is relocated from the first region to the second region based on the respective score data.

10. The system of claim 7, wherein the adaptive canary qubit system determines a noise map based on the respective score data of the respective noise hotspots.

11. The system of claim 1, wherein the adaptive canary qubit system applies a gate sequence to the canary qubit to measure the state data of the canary qubit.

12. A method, comprising:
obtaining, by a system comprising at least one non-quantum processor that executes an adaptive canary qubit system, a telemetry dataset representative of current operational data associated with a quantum processing unit;
determining, by the system based on the telemetry dataset, a noise map representative of respective hotspots and respective non-hotspots in respective regions of the quantum processing unit, wherein the respective hotspots comprise respective sets within the respective regions of the respective regions that satisfy defined noise threshold data;
determining, by the system, an error state corresponding to a canary qubit operating in a respective hotspot of the respective hotspots; and
in response to the determining the error state, reassigning, by the system, an active logical qubit operating in the respective hotspot to a respective non-hotspot region of the respective non-hotspots of the quantum processing unit.

13. The method of claim 12, further comprising determining respective score data for the respective hotspots, and ranking the respective hotspots in a priority ordering.

14. The method of claim 12, wherein the telemetry data comprises current telemetry data, and further comprising predicting, by the system, placement of the canary qubit in the respective hotspot of the respective hotspots based on the current telemetry data and historical telemetry data.

15. The method of claim 12, further comprising preprocessing, by the system, raw data collected from sensors deployed in the quantum processing unit, to obtain the telemetry data.

16. The method of claim 12, wherein the determining of the error state comprises applying a gate sequence to the canary qubit, and measuring resulting state data of the canary qubit after the applying of the gate sequence, to determine that the resulting state data is in an incorrect state.

17. A system, comprising:
at least one processor; and
at least one memory that stores executable instructions that, when executed by the at least one processor, facilitate performance of operations, the operations comprising:
obtaining respective telemetry data representative of respective environmental data of respective regions of a quantum processing unit;
obtaining respective noise data of the respective regions based on the respective telemetry data;
determining, based on the respective noise data and defined noise threshold data, that a first region of the respective regions is a hotspot region based on the first region satisfying the noise threshold data;
determining, based on the respective noise data and the defined noise threshold data, that a second region of the respective regions is a non-hotspot region based on the second region not satisfying the noise threshold data;
measuring a canary qubit in the first region to determine that the canary qubit is in an error state; and
reassigning an active logical qubit from the first region to the second region.

18. The system of claim 17, wherein the operations further comprise generating a heat map based on the respective noise data of the respective regions, determining respective priority scores of the respective regions based on the respective noise data, and ranking the respective regions based on the respective priority scores.

19. The system of claim 17, wherein the telemetry data comprises real-time telemetry data, and wherein the operations further comprise predicting placement of the canary qubit in the first region based on the real-time telemetry data and historical telemetry data.

20. The system of claim 17, wherein the measuring of the canary qubit comprises applying a gate sequence to the canary qubit to determine that the canary qubit is in the error state based on the canary qubit not being in an expected state after the applying of the gate sequence.
